(19) United States
(12) Patent Application Publication
(10) Pub. No.: US 2020/0074413 A1
(43) Pub. Date: Mar. 5, 2020

(54) ROAD MAINTENANCE MANAGEMENT SYSTEM, ROAD MAINTENANCE MANAGEMENT METHOD, AND A NON-TRANSITORY RECORDING MEDIUM

(71) Applicants: Kabushiki Kaisha Toshiba, Minato-ku (JP); Toshiba Infrastructure Systems & Solutions Corporation, Kawasaki-shi (JP)

(72) Inventors: Yoko YONEKAWA, Fuchu (JP); Nobuyuki Kumakura, Sagamihara (JP); Masaki Shiratsuki, Yokohama (JP); Yuri Kitani, Kawasaki (JP)

(73) Assignees: Kabushiki Kaisha Toshiba, Minato-ku (JP); Toshiba Infrastructure Systems & Solutions Corporation, Kawasaki-shi (JP)

(21) Appl. No.: 16/546,905

(22) Filed: Aug. 21, 2019

(30) Foreign Application Priority Data
Aug. 28, 2018 (JP) 2018-159654

(51) Int. Cl. G06Q 10/00; G06Q 50/08; B60W 40/06; G06Q 10/06; G06K 9/00

(52) U.S. Cl. CPC G06Q 10/20; G06Q 50/08; G06K 9/00798; G06Q 10/06311; B60W 40/06

(57) ABSTRACT

A road maintenance management system according to an embodiment includes a road surface damage state information acquisition unit, a road environment information acquisition unit, a construction method and structure list acquisition unit, and a repair candidate list generator. The road surface damage state information acquisition unit is configured to acquire road surface damage state information indicating a damage state of a road surface of a management target. The road environment information acquisition unit is configured to acquire environment information of the road surface. The construction method and structure list acquisition unit is configured to acquire a construction method and structure list indicated by information regarding a repair of a road surface in accordance with a structure level of the road surface. The repair candidate list generator is configured to review a structure of the road surface in accordance with the environment information of the road surface and generate a repair candidate list including a repair method for the road surface according to a determination result for each a repair candidate of the road surface using the road surface damage state information and the construction method and structure list.

### CROSS-REFERENCE TO RELATED APPLICATION

This application is based upon and claims the benefit of priority from Japanese Patent Application No. 2018/159654 filed on Aug. 28, 2018, and the entire contents of which are incorporated herein by reference.

### FIELD

Embodiments described herein relate generally to a road maintenance management system, a road maintenance management method, and a non-transitory recording medium.

### BACKGROUND

In the related art, maintenance management is performed on roads according to periodic inspection, daily inspection, or notification information from residents, and thus maintenance and repair are performed in accordance with inspection results or notification content. In the methods of the related art, however, since the methods are symptomatic and the degree of deterioration are not taken into account, road structure review is not performed in accordance with preventive maintenance, fast maintenance and repair in which life cycle cost is reflected, or a use situation, same spots are maintained and repaired several times in a short time, and maintenance cost is thus high in some cases.

### BRIEF DESCRIPTION OF THE DRAWINGS

FIG. 1 is a schematic diagram showing a road maintenance management system according to an embodiment.

FIG. 2 is a diagram showing a configuration of the road maintenance management system according to a first embodiment.

FIG. 3 is a diagram showing a configuration example of a road surface damage state table according to the embodiment.

FIG. 4 is a diagram showing a configuration example of a road environment table according to the embodiment.

FIG. 5 is a diagram showing a configuration example of a management road table according to the embodiment.

FIG. 6 is a diagram showing a configuration example of a road structure table according to the embodiment.

FIG. 7 is a diagram showing a configuration example of a construction method and structure list table according to the embodiment.

FIG. 8 is a diagram showing a configuration example of a repair history table according to the embodiment.

FIG. 9 is a flowchart showing a flow of a repair candidate list generation process performed in the road maintenance management system according to the first embodiment.

FIG. 10 is a diagram showing an example of a repair candidate list according to the embodiment.

FIG. 11 is a diagram showing a screen example displayed on a display according to the embodiment.

FIG. 12 is a diagram showing a configuration of a road maintenance management system according to a second embodiment.

FIG. 13 is a flowchart showing a flow of a construction schedule generation process performed by the road maintenance management system according to the second embodiment.

FIG. 14 is a diagram showing an example of a construction schedule according to the embodiment.

### DETAILED DESCRIPTION

The present invention provides a road maintenance management system, a road maintenance management method, and a non-transitory recording medium capable of determining an appropriate maintenance and repair method according to the degree of deterioration or a use situation of a road.

According to one embodiment, a road maintenance management system according to an embodiment includes a road surface damage state information acquisition unit, a road environment information acquisition unit, a construction method and structure list acquisition unit, and a repair candidate list generator. The road surface damage state information acquisition unit is configured to acquire road surface damage state information indicating a damage state of a road surface of a management target. The road environment information acquisition unit is configured to acquire environment information of the road surface. The construction method and structure list acquisition unit is configured to acquire a construction method and structure list indicated by information regarding a repair of a road surface in accordance with a structure level of the road surface. The repair candidate list generator is configured to perform a review a structure of the road surface in accordance with the environment information of the road surface and generate a repair candidate list including a repair method for the road surface according to a determination result for each a repair candidate of the road surface using the road surface damage state information and the construction method and structure list.

Hereinafter, a road maintenance management system, a road maintenance management method, and a non-transitory recording medium according to embodiments will be described with reference to the drawings.

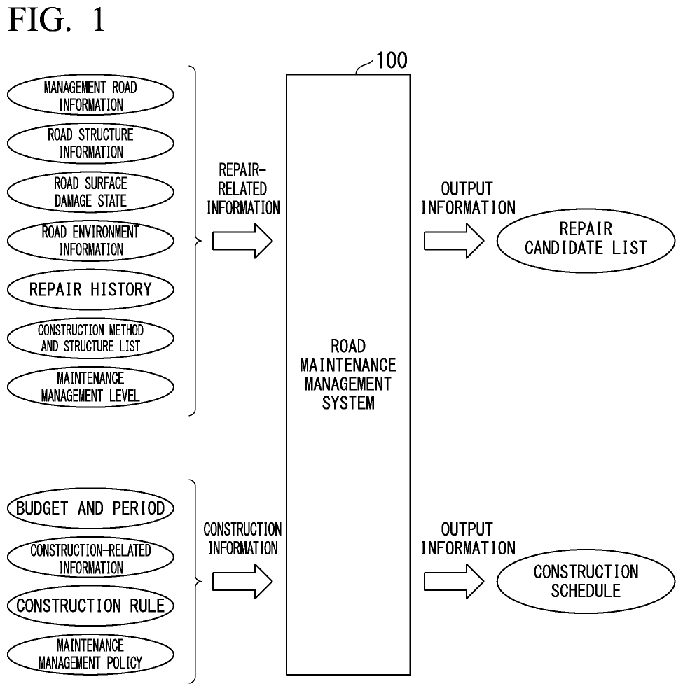

FIG. 1 is a schematic diagram showing a road maintenance management system 100 according to an embodiment.

The road maintenance management system 100 according to the embodiment is a system that supports maintenance management work by forming information necessary for maintenance or repair as a repair candidate list of management target roads according to an inspection result of roads, generating a maintenance construction schedule of a route according to the repair candidate list, and supplying the maintenance construction schedule to a road manager. The road manager mentioned here is a public organization such as a state or local public organization or a road service provider that manages and administrates highways or toll roads. The roads mentioned here are, for example, public roads (including not only general roads and highways) that are managed by a road manager. The roads according to the embodiment may include roads of a campus in a factory.

The road maintenance management system 100 generates a repair candidate list according to repair-related information shown in FIG. 1 and generates a construction schedule according to the repair candidate list and construction information.

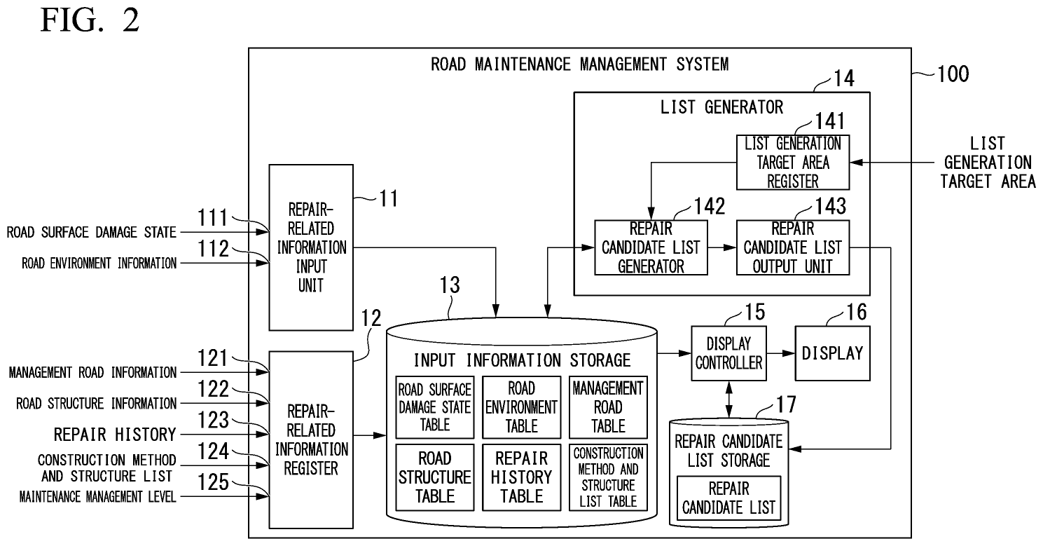

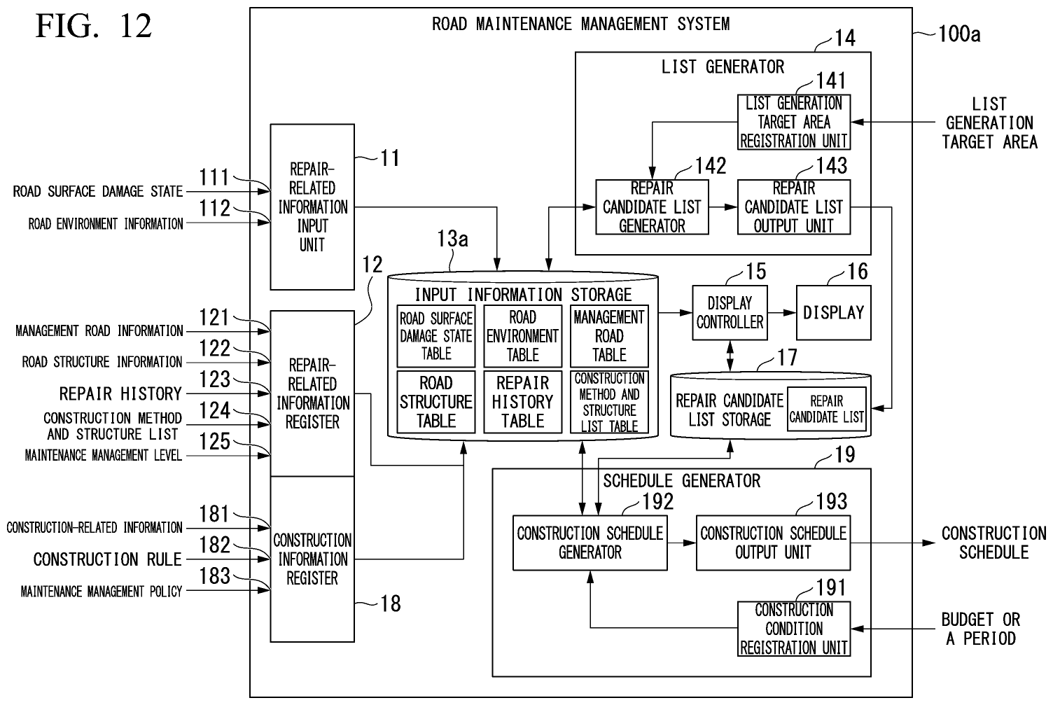

First, the repair-related information is information used to generate the repair candidate list and is, for example, various kinds of information such as management road information, road structure information, a road surface damage state, road environment information, a repair history, a construction method and structure list, and a maintenance management level. The various kinds of information such as the management road information, the road structure information, the road surface damage state, the road environment information, the repair history, the construction method and structure list, and the maintenance management level will be described in detail with reference to FIG. 2. The construction information is information regarding roads on which construction such as maintenance or repair is performed and is, for example, various kinds of information such as a budget and a period, construction-related information, a construction rule, and a maintenance management policy. The various kinds of information such as the budget and the period, the construction-related information, the construction rule, and the maintenance management policy will be described in detail with reference to FIG. 12.

Hereinafter, each embodiment will be described in detail.

### First Embodiment

First, a first embodiment will be described. The first embodiment is an embodiment in which the repair candidate list is generated using the repair-related information.

FIG. 2 is a diagram showing a configuration of the road maintenance management system 100 according to the first embodiment. The road maintenance management system 100 includes one information processing device or a plurality of information processing devices. When the road maintenance management system 100 includes one information processing device, the road maintenance management system 100 includes a central processing unit (CPU), a memory, and an auxiliary storage device connected by a bus and executes a road maintenance management program. The road maintenance management system 100 includes a repair-related information input unit 11, a repair-related information register 12, an input information storage 13, a list generator 14, a display controller 15, a display 16, and a repair candidate list storage 17 by executing the road maintenance management program. Some or all of the functions of the road maintenance management system 100 may be realized using hardware such as an application specific integrated circuit (ASIC), a programmable logic device (PLD), or a field programmable gate array (FPGA). The road maintenance management program may be recorded on a computer-readable recording medium. The computer-readable recording medium is, for example, a storage device such as a hard disk contained in a computer system or a portable medium such as a flexible disc, a magneto-optical disc, a ROM, a CD-ROM. The road maintenance management program may be transmitted via an electric communication line.

The repair-related information input unit 11 is an input unit that inputs various kinds of information such as a road surface damage state and road environment information obtained at the time of a road inspection to the own system. The repair-related information input unit 11 includes a road surface damage state information acquisition unit 111 and a road environment information acquisition unit 112.

The road surface damage state information acquisition unit 111 is a functional unit that acquires information regarding a road surface damage state. The information regarding the road surface damage state is information indicating the degree of damage of a road surface.

As types of damage of a road surface, there are a crack, a depression, a rut, unevenness in a longitudinal direction, and the like. As the degree of damage of a road surface, there are a depth, an area, and a damage situation of damage (for example, whitening due to minuteness of crack, extraction of fine particle fraction, and the like). The degree of damage is classified into large, medium, and small damages according to standards of predetermined depths and damage ranges.

Here, the information regarding the road surface damage state is acquired by an in-vehicle device by performing road inspection.

First, through measurement of a road surface depression, information regarding the depth of a road surface depression and a damage range is acquired by a laser scanner (3D dot group) mounted on a vehicle. As another measurement method for a road surface depression, the in-vehicle device may acquire a depth of a road surface depression, a damage range, and the degree of damage by performing measurement using an image captured by an in-vehicle stereo camera or 3D dot group data generated from the image. As still another measurement method for a road surface depression, the in-vehicle device may acquire the degree of damage by performing determination through image processing of a moving image captured by a video camera or a still image.

Next, a crack measurement method will be described. The in-vehicle device acquires the damage range and the degree of damage of a crack by performing measurement through image processing of a moving image captured by a video camera or still images. The damage range may be calculated by converted into ortho-images using GPS information associated with the still images or the still images may be extracted at a constant distance interval and the number of still images including the damage may be counted and calculated.

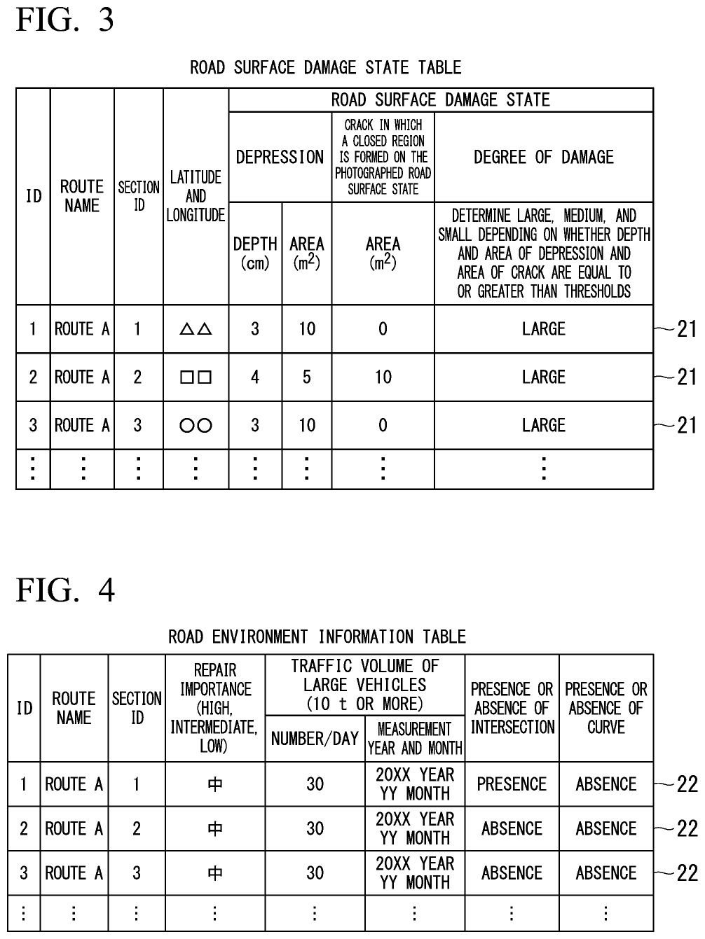

The road surface damage state information acquisition unit 111 stores the information regarding the road surface damage state acquired in this way and stores the information regarding the road surface damage state as a road surface damage state table shown in FIG. 3 in the input information storage 13.

FIG. 3 is a diagram showing a configuration example of a road surface damage state table.

The road surface damage state table shown in FIG. 3 includes a plurality of records 21 in which the information regarding the road surface damage state is recorded (hereinafter referred to as “road surface damage state records”). The road surface damage state record 21 has values of an ID, a route name, a section ID, latitude and longitude, and a road surface damage state. The value of an ID in the road surface damage state table represents identification information for identifying the road surface damage state record 21. The value of the route name represents the name of a route of a management target road. The value of a section ID represents identification information for identifying a section of the route of the management target road. Each route is partitioned into a plurality of sections at a certain fixed distance. The sections can be generated in a personal computer (not shown) or the like. The value of latitude and longitude represents latitude and longitude of the sections of the route of the management target road. The value of a road surface damage state represents the degree of damage of a road surface. The value of a road surface damage state is registered for each section or each piece of damage.

In the example shown in FIG. 3, the plurality of road surface damage state records 21 are registered in the road surface damage state table. In FIG. 3, in the road surface damage state record 21 registered in the uppermost row of the road surface damage state table, the value of the ID is “1,” the value of the route name is “route A,” the value of the section ID is “1,” the value of latitude and longitude is “ΔΔ,” the value of a depth (cm) of a road surface depression which is a road surface damage state is “3,” the value of an area (m²) of the road surface depression is “10,” and the value of the degree of damage is “large.” That is, the section of the route identified by the section ID “1” of the route A shows that the latitude and longitude is “ΔΔ,” the road surface depression occurs, the depth of the road surface depression is “3 cm,” the area of the damage range of the road surface depression is “10 m²,” and the degree of damage of the road surface is “large.”

Back in FIG. 2, the road environment information acquisition unit 112 is a functional unit that acquires road environment information. The road environment information is information regarding a road environment. As the road environment, there is a traffic volume of large vehicles, presence or absence of an intersection, and presence or absence of a curve. The road environment information acquisition unit 112 acquires the road environment information from another system or acquires the road environment information when a manager, a person concerned with the road, or the like performs a registration input. The road environment information acquisition unit 112 stores the acquired road environment information as a road environment table shown in FIG. 4 in the input information storage 13.

FIG. 4 is a diagram showing a configuration example of a road environment table.

The road environment table shown in FIG. 4 includes a plurality of records 22 in which information regarding an environment of roads is registered (hereinafter referred to as “road environment records”). The road environment record 22 has values of an ID, a route name, a section ID, repair importance, a traffic volume of large vehicles, presence or absence of an intersection, and presence or absence of a curve. The value of the ID in the road environment table represents identification information for identifying the road environment record 22. The value of the route name represents the name of a route of a management target road. The value of the section ID represents identification information for identifying a section of the route of the management target road.

The value of the repair importance represents the degree of importance of repair of the section of the route identified with the section ID. As the value of the repair importance, one value of three “high,” “intermediate,” and “low” is set in accordance with a maintenance management level such as a use frequency or presence or absence of a school zone. The value of the repair importance is not input at a time point at which the road environment table is generated and is registered in accordance with the maintenance management level input to the repair-related information register 12 by the repair-related information register 12. The value of the traffic volume of large vehicles represents a traffic volume of large vehicles (for example, vehicles of 10 t or more) per day. The value of presence or absence of an intersection represents whether there is an intersection in a section of the route identified with the section ID. The value of presence or absence of a curve represents whether there is a curve in the section of the route identified with the section ID.

In the example shown in FIG. 4, the plurality of road environment records 22 are registered in the road environment table. In FIG. 4, in the road environment record 22 registered in the uppermost row of the road environment table, the value of the ID is “1,” the value of the route name is “route A,” the value of the section ID is “1,” the value of the repair importance is “high,” the value of the traffic volume of large vehicles per day as the traffic volume of large vehicles is “30,” the value of measurement year and month of the traffic volume of large vehicles is “2XX, YY,” the value of presence or absence of an intersection is “presence,” and the value of presence or absence of a curve is “absence.” That is, the section of the route identified with the section ID “1” of route A shows that the degree of importance of repair is “intermediate,” the traffic volume of large vehicles per day is “30,” the value of measurement year and month of the traffic volume of large vehicles is “20XX, YY,” the intersection is “presence,” and the curve is “absence.”

Back in FIG. 2, the repair-related information register 12 is a registration unit that registers various kinds of information regarding management road information, road structure information, a repair history, a construction method and structure list, and a maintenance management level input through an operation by the manager in the own system. The repair-related information register 12 includes a management road information acquisition unit 121, a road structure information acquisition unit 122, a repair history acquisition unit 123, a construction method and structure list acquisition unit 124, and a maintenance management level acquisition unit 125. The repair-related information register 12 may acquire various kinds of information regarding management road information, road structure information, a repair history, a construction method and structure list, and a maintenance management level input through an operation by the manager from another system.

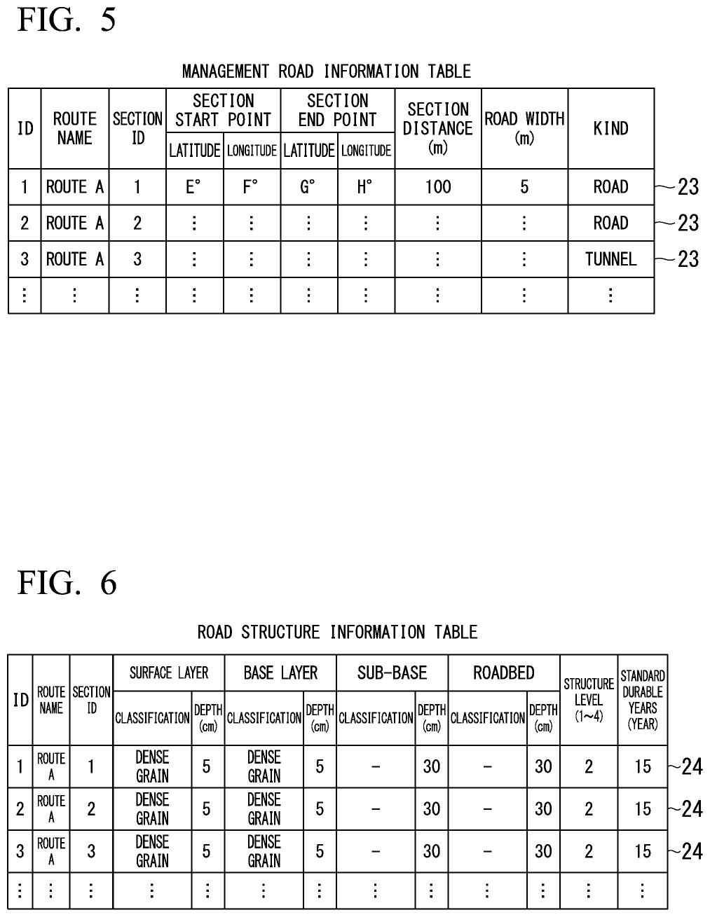

The management road information acquisition unit 121 is a functional unit that acquires management road information. The management road information is information regarding a management target road and includes, for example, information indicating attributes of a road such as a route name, a section ID, a section start point, a section end point, a section distance, a road width, and a type. The management road information acquisition unit 121 stores the acquired management road information in the input information storage 13 as a management road information table shown in FIG. 5.

FIG. 5 is a diagram showing a configuration example of a management road table.

The management road table shown in FIG. 5 includes a plurality of records 23 in which information regarding management target roads (hereinafter referred to as “management road recodes”) is registered. The management road record 23 includes values of a route name, a section ID, a section start point, a section end point, a section distance, a road width, and a type for each ID. A value of an ID in the management road table represents identification information for identifying the management road record 23. The value of the route name represents the name of a route of a management target road. The value of the section ID represents identification information for identifying a section of the route of the management target road. The value of the section start point represents a position (for example, latitude and longitude) of a start point of the section identified with the section ID. The value of the section end point represents a position (for example, latitude and longitude) of an end point of the section identified with the section ID. The value of the section distance represents a distance of the section identified with the section ID. The section distance is the distance between the section start point and the section end point. The value of the road width represents a road width of the section identified with the section ID. The value of the type represents a kind of section identified with the section ID. The kinds of section are kinds of sections into which sections of the route are classified and include, for example, a road and a tunnel.

In the example shown in FIG. 5, the plurality of management road records 23 are registered in the management road table. In FIG. 5, in the management road record 23 registered in the uppermost row of the management road table, the value of the ID is “1,” the value of the route name is “route A,” the value of the section ID is “1,” the value of the latitude of the section start point is “E°,” the value of the longitude of the section start point is “F°,” the value of the latitude of the section end point is “G°,” the value of the longitude of the section end point is “H°,” the value of the section distance is “100,” the value of the road width is “5,” and the value of the kind is “road.” That is, the section of the route identified with the section ID “1” of route A is a section from a spot of latitude “E°” and longitude “F°” to a spot of latitude “G°” and longitude “H°,” the section distance is “100 m,” the road width is “5 m,” and the kind is classified into “road.”

Back in FIG. 2, the road structure information acquisition unit 122 is a functional unit that acquires information regarding a road structure. The road structure is information regarding a structure of a management target road and includes, for example, information such as a route name, a section ID, a surface layer, a base layer, a sub-base, a roadbed, and a structure level. The road structure information acquisition unit 122 stores the acquired information regarding the road structure as a road structure table shown in FIG. 6 in the input information storage 13.

FIG. 6 is a diagram showing a configuration example of a road structure table. The road structure table shown in FIG. 6 includes a plurality of records 24 in which information regarding the structure of a road (hereinafter referred to as “road structure records”) is registered. In the road structure record 24, values of a route name, a section ID, a classification and depth of a surface layer, a classification and depth of a base layer, a classification and depth of a sub-base, a classification and depth of a roadbed, a structure level, and standard durable years for each ID are associated with each other for registration.

The value of the ID in the road structure table represents identification information for identifying the road structure record 24. The value of the route name represents the name of the route of the management target road. The value of the section ID represents identification information for identifying the section of the route. The surface layer represents an upper layer of an asphalt pavement slab with two layers. The base layer represents a lower layer of the asphalt pavement slab with two layers. The sub-base represents a portion which is a ground of the asphalt pavement slab. The roadbed is located in a layer lower than the sub-base in a portion of the groundsill of a road. The value of the structure level represents the degree of strength of a road structure of the section decided from depths of the sub-base, the roadbed, the base layer, and the surface layer. The structure level is indicated with 1 to 4 and represents that the strength of the road structure is higher as its value is smaller. The value of the standard durable years represents durable years of the section. The value of the standard durable years is decided in accordance with the maintenance management level. The value of the standard durable years is not input at a time point at which the road structure table is generated and is registered by the repair-related information register 12 in accordance with a maintenance management level input to the repair-related information register 12.

In the example shown in FIG. 6, the plurality of road structure records 24 are registered in the road structure table. In FIG. 6, in the road structure record 24 registered in the uppermost row of the road structure table, the value of the ID is “1,” the value of the route name is “route A,” the value of the section ID is “1,” the value of the classification of surface layer is “dense grain,” the value of the depth (cm) of the surface layer is “5,” the value of the classification of base layer is “dense grain,” the value of the depth (cm) of the base layer is “5,” the value of the classification of sub-base is the value of the depth (cm) of the sub-base is “30,” the value of the classification of roadbed is “-,” the value of the depth (cm) of the roadbed is “-,” the value of the structure level is “2,” and the value of the standard durable years is “15.” That is, the route of the section identified with the section ID “1” of route A shows that the surface layer has “dense grain” of the depth of “5 cm,” the base layer has “dense grain” of the depth of “5 cm,” the sub-base has the depth of “30 cm,” the roadbed has the depth of “30 cm,” the rank of the road structure is “2,” and the durable years is “15 years.”

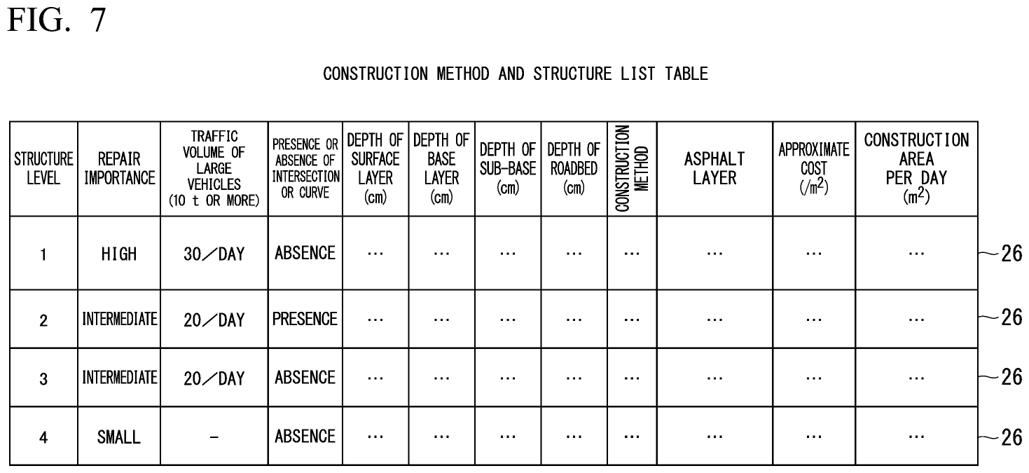

Back in FIG. 2, the construction method and structure list acquisition unit 124 is a functional unit that acquires a construction method and structure list. The construction method and structure list is a file that indicates information regarding a repair of a road surface in accordance with a structure level of the road surface and includes, for example, information such as a structure level, repair importance, a traffic volume of large vehicles, presence or absence of an intersection or a curve, the depth of a surface layer, the depth of a base layer, the depth of a sub-base, the depth of a roadbed, a construction method, an asphalt layer, an approximate cost, and a construction area per day. The construction method and structure list acquisition unit 124 stores the acquired construction method and structure list as a construction method and structure list table shown in FIG. 7 in the input information storage 13.

FIG. 7 is a diagram showing a configuration example of a construction method and structure list table.

The construction method and structure list table shown in FIG. 7 includes a plurality of records 26 in which information regarding construction (hereinafter referred to as “construction method and structure records”) are registered. The construction method and structure record 26 has values of repair importance, a traffic volume of large vehicles, presence or absence of an intersection point or a curve, the depth of a surface layer, the depth of a base layer, the depth of a sub-base, the depth of a roadbed, a construction method, an asphalt layer, an approximate cost, and a construction area per day for each structure level.

The value of the structure level represents the degree of strength of the road structure. The value of the repair importance represents the degree of importance of repair in the section of the route identified with the section ID. The value of the traffic volume of large vehicles represents a standard for a traffic volume of large vehicles (for example, vehicles of 10 t or more) per day. The value of the presence or absence of the intersection point or the curve represents presence or absence of one of an intersection and a curve in the section of the route identified with the section ID. The “presence” in the value of an intersection or a curve represents that there is one or both of the intersection and the curve in the section of the route. The “absence” in the value of an intersection or a curve represents that there is neither an intersection nor a curve in the section of the route.

The value of the depth of a surface layer represents the depth of the surface layer which is processed by a construction method. The value of the depth of a base layer represents the depth of the base layer which is processed by a construction method. The value of the depth of a sub-base represents the depth of the sub-base which is processed by a construction method. The value of the depth of a roadbed represents the depth of the roadbed which is processed by a construction method.

The value of the construction method represents a kind of construction method for repair. As kinds of construction methods, there are sub-base replacement, surface layer and base layer changing, surface layer changing, overlaying, patching, and the like.

A road surface structure of a road is stacked in the order of a surface layer, a base layer, and a sub-base from the surface layer side. As kinds of construction methods, for example, there are sub-base replacement, surface layer and base layer changing, surface layer changing, overlaying, and patching in the order of scales of construction. Here, sub-base replacement is the largest scale of construction which is construction for replacing a surface layer, a base layer, and a sub-base. The surface layer and base layer changing is construction for replacing only a surface layer and a base layer without replacing a sub-base. The surface layer changing is construction for replacing only a surface layer without replacing a base layer and a sub-base. The overlaying is construction for superimposing a surface layer on a surface layer for repair. Patching is construction for mending only a spot necessary for repair.

The value of an asphalt layer represents a kind of asphalt layer included in a road surface.

The value of the approximate cost represents an approximate cost per m² occurring to perform repairing in accordance with a construction method. The value of a construction area per day represents an area per day in which repairing can be performing in accordance with a construction method.

The values of the construction method, the asphalt layer, the approximate cost, and the construction area per day are set in association with each time of rank-up and rank maintenance of the structure level. The time of rank-up of the structure level is a case in which a structure level is higher due to repair than a structure level at a current time of a road surface. The time of rank maintenance of the structure level is a case in which a structure level is not changed from the structure level at the current time of the road surface.

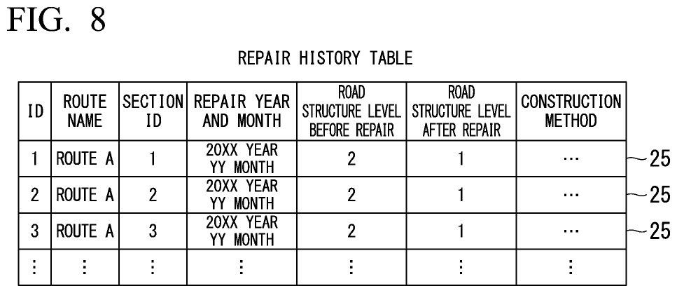

Back in FIG. 2, the repair history acquisition unit 123 is a functional unit that acquires information regarding a repair history. The repair history is information regarding a history of repairs performed on management target roads and includes, for example, information such as a route name, a section ID, a repair year and month, a road structure level before repair, a road structure level after repair, and a construction method. The repair history acquisition unit 123 stores the acquired information regarding the repair history as a repair history table shown in FIG. 8 in the input information storage 13.

FIG. 8 is a diagram showing a configuration example of a repair history table.

The repair history table shown in FIG. 8 includes a plurality of records 25 in which information regarding history of repairs (hereinafter referred to as “repair history records”) is registered. In the repair history record 25, values of a route name, a section ID, a repair year and month, a road structure before repair, road surface damage, and a construction method for each ID are associated with each other.

The value of the ID in the repair history table represents identification information for identifying the repair history record 25. The value of the route name represents the name of the route of the management target road. The value of the section ID represents identification information for identifying the section of the route of the management target road. The value of the repair year and month represents years in which repair has been performed in the section of the route identified with the section ID. The value of the road structure level before repair represents a road structure level before repair is performed in the section of the route identified with the section ID. The value of the road structure level after repair represents a road structure level after repair is performed in the section of the route identified with the section ID.

The value of the construction method represents a construction method of repair performed in the section.

Back in FIG. 2, the maintenance management level acquisition unit 125 is a functional unit that acquires information regarding a maintenance management level. The maintenance management level is a value determined for maintenance management of a road by a manager. For example, the maintenance management level is determined for each item of the standard durable periods, the degree of damage, and the repair importance of the route. The maintenance management level acquisition unit 125 stores information regarding the acquired maintenance management level in the input information storage 13. For example, the maintenance management level acquisition unit 125 additionally registers the value of the standard durable years for each section acquired as the information regarding the maintenance management level to the item of the standard durable years of the road structure table. For example, the maintenance management level acquisition unit 125 additionally registers the value of the repair importance for each section acquired as the information regarding the maintenance management level to the item of the repair importance of the road environment table.

Back in FIG. 2, the list generator 14 includes a list generation target area register 141, a repair candidate list generator 142, and a repair candidate list output unit 143.

The list generation target area register 141 is a registration unit that registers an area which is a generation target of a repair candidate list (hereinafter referred to as a “list generation target area”). The list generation target area is an area which is a target on which necessity or non-necessity of repair is examined. The list generation target area register 141 may register the list generation target area, for example, when the list generation target area is input from an external device, or may register the list generation target area when the list generation target area is input from an input device such as a keyboard, a mouse, or the like directly connected to the list generation target area register 141. As the list generation target area, a maintenance management area may be designated, a route may be designated, or a section may be designated.

The repair candidate list generator 142 is a generation unit that generates a repair candidate list according to information stored in the input information storage 13 and information regarding a target area registered by the list generation target area register 141.

The repair candidate list output unit 143 is a functional unit that outputs the repair candidate list generated by the repair candidate list generator 142. For example, the repair candidate list output unit 143 stores the repair candidate list in the repair candidate list storage 17. The repair candidate list output unit 143 may transmit the repair candidate list to an external device via a network, may be connected to a printing device and output the repair candidate list to a medium via the printing device, or may output the repair candidate list to an external recording medium such as a universal serial bus (USB) or an SD card.

The display controller 15 is a display controller that generates display screen data according to the information stored in the input information storage 13 and causes the display 16 to display the display screen data. The display controller 15 generates, for example, screen data including a mending or repair history and images of a road structure and a road as the display screen data.

The display 16 is a display that displays the screen data input from the display controller 15 on a screen. The display 16 is, for example, a liquid crystal display device.

The repair candidate list storage 17 is a storage unit that stores the repair candidate list generated by the list generator 14. The repair candidate list storage 17 is configured using a storage device such as a magnetic hard disk device or a semiconductor storage device.

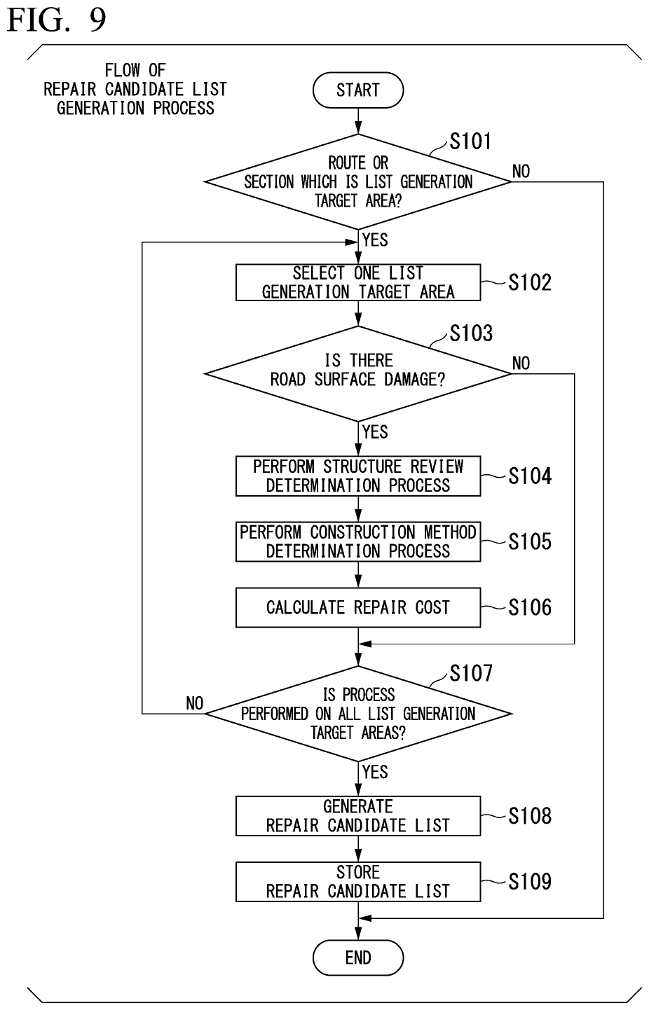

FIG. 9 is a flowchart showing a flow of a repair candidate list generation process performed in the road maintenance management system 100 according to the first embodiment.

In step S101, the repair candidate list generator 142 determines whether one of the route or the section which is the list generation target area is registered by the list generation target area register 141.

When there is the route or the section which is the list generation target area (YES in step S101), the repair candidate list generator 142 performs a process of step S102. Conversely, when there is no route or section which is the list generation target area (NO in step S101), the repair candidate list generator 142 ends the process of FIG. 9.

In step S102, the repair candidate list generator 142 selects one list generation target area among the list generation target areas.

In step S103, the repair candidate list generator 142 determines whether there is road surface damage in the selected list generation target area. Specifically, the repair candidate list generator 142 first reads the road surface damage state table stored in the input information storage 13 described with reference to FIG. 3.

The repair candidate list generator 142 selects the road surface damage state record 21 corresponding to the list generation target area in the road surface damage state table. When one route is selected in the list generation target area, the repair candidate list generator 142 selects all the road surface damage state records 21 corresponding to the selected route.

The repair candidate list generator 142 determines the degree of damage from the selected road surface damage state record 21 in accordance with the depth and area of a depression and a crack area.

For example, the repair candidate list generator 142 determines that the degree of damage is “large” when the area of a crack is equal to or greater than a decided threshold as each degree of damage in the section. The repair candidate list generator 142 determines that the degree of damage is “large” when the area of the crack is equal to or greater than a certain threshold as each degree of damage in the section and there is a road surface depression.

The repair candidate list generator 142 determines that the degree of damage is “large” when a total area of damage (a plurality of pieces of damage) occupied in one section (hereinafter referred to as a “damage area”) is equal to or greater than a first threshold (for example, 50% or more) of the entire section. The repair candidate list generator 142 determines that the degree of damage is “medium” when the damage area is less than the first threshold of the entire section and is equal to or greater than a second threshold (for example, 30% or more). The repair candidate list generator 142 determines that the degree of damage is “small” when the damage area is less than the second threshold of the entire section.

The repair candidate list generator 142 determines that there is the road surface damage in the list generation target area when there is the degree of damage that is “large” in the selected list generation target area. Conversely, in other cases, the repair candidate list generator 142 determines that there is no road surface damage in the list generation target area.

When there is the road surface damage in the selected list generation target area (YES in step S103), the repair candidate list generator 142 performs the process of step S104 on the list generation target area (a spot or a section in which the degree of damage is “large”) in which it is determined that there is the road surface damage.

Conversely, when there is no road surface damage in the selected list generation target area (NO in step S103), the repair candidate list generator 142 performs the process of step S107.

In step S104, the repair candidate list generator 142 performs a structure review determination process. The structure review determination process is a process of determining whether it is necessary to reexamine the road structure and how it is necessary to reexamine the road structure, from the degree of damage.

Specifically, the repair candidate list generator 142 reads the road environment table (see FIG. 4), the road structure table (see FIG. 6), and the repair history table (see FIG. 8) stored in the input information storage 13.

Subsequently, the repair candidate list generator 142 selects the road environment record 22 corresponding to the list generation target area in which it is determined that there is the road surface damage among the road environment records 22 of the read road environment table. At this time, when one section is selected from the list generation target areas, the repair candidate list generator 142 selects the road environment record 22 corresponding to the section ID for identifying the selected section. When one route is elected in the list generation target area, the repair candidate list generator 142 selects all the road environment records 22 corresponding to the selected route.

Similarly, the repair candidate list generator 142 selects the road structure record 24 corresponding to the list generation target area in which it is determined that there is the road surface damage among the road structure records 24 of the read road structure table. At this time, when one section is selected in the list generation target area, the repair candidate list generator 142 selects the road structure record 24 corresponding to the section ID for identifying the selected section. When one route is selected in the list generation target area, the repair candidate list generator 142 selects all the road structure records 24 corresponding to the selected route.

Similarly, the repair candidate list generator 142 selects the repair history record 25 corresponding to the list generation target area in which it is determined that there is the road surface damage among the repair history records 25 of the read repair history table. At this time, when one section is selected in the list generation target area, the repair candidate list generator 142 selects the repair history record 25 corresponding to the section ID for identifying the selected section. When one route is selected in the list generation target area, the repair candidate list generator 142 selects all the repair history records 25 corresponding to the selected route.

Then, the repair candidate list generator 142 determines whether it is necessary to reexamine the structure and how it is necessary to reexamine the road structure with reference to the items of the repair importance, the traffic volume of large vehicles, the presence or absence of an intersection, and the presence or absence of a curve registered in the selected road environment record 22, the item of the standard durable years registered in the road structure record 24, and the item of the repair year and month registered in the repair history record 25.

The repair candidate list generator 142 compares elapsed years from previous repair indicated in the item of the repair year and month to a year and month of the current time point with the standard durable years and determines that it is not necessary to reexamine the structure when the elapsed years are longer than the standard durable years.

Conversely, when the elapsed years are shorter than the standard durable years, the repair candidate list generator 142 determines that it is necessary to reexamine the structure. This is because when the elapsed years are shorter than the standard durable years, there is a high possibility of a certain problem being in a road structure, such as an unmatched problem between the road structure and the traffic volume of large vehicles. In this case, the repair candidate list generator 142 performs the review of the structure so that the structure level is changed to a structure level suitable for a road environment condition.

When it is necessary to reexamine the structure, the repair candidate list generator 142 specifies the traffic volume of large vehicles, the repair importance, and the presence or absence of an intersection or a curve of the list generation target area in which it is determined that it is necessary to reexamine the structure. Then, the repair candidate list generator 142 changes the structure level of the list generation target area in which it is determined that it is necessary to reexamine the structure to the structure level suitable for the road environment condition in accordance with the traffic volume of large vehicles, the repair importance, and the presence or absence of an intersection or a curve of the specified list generation target area. Then, the repair candidate list generator 142 selects the construction method necessary for the structure in the construction method and structure list table. The construction method necessary in the change in the structure level is assumed to be defined in advance and registered in the system.

Conversely, when it is not necessary to reexamine the structure, the repair candidate list generator 142 does not change the construction method on the list generation target area in which it is determined that it is not necessary to reexamine the structure.

In step S105, the repair candidate list generator 142 performs a construction method determination process. The construction method determination process is a process of determining a construction method performed on the list generation target area in which it is determined that it is necessary to reexamine the structure. Specifically, the repair candidate list generator 142 first reads the construction method and structure list table stored in the input information storage 13. Subsequently, the repair candidate list generator 142 selects the construction method record 26 suitable as a construction method for the list generation target area in which it is determined that it is necessary to reexamine the structure with reference to the construction method record 26 of the read construction method and structure list table. For example, the repair candidate list generator 142 selects the construction method record 26 in accordance with the structure level suitable for the road environment condition as the structure level of the list generation target area in which it is determined that it is necessary to reexamine the structure. Then, the repair candidate list generator 142 selects the construction method indicated in the item of the construction method of the construction method record 26 as a construction method performed on the list generation target area in which it is determined that it is necessary to reexamine the structure.

In step S106, the repair candidate list generator 142 calculates repair cost in accordance with the selected construction method. Specifically, the repair candidate list generator 142 calculates repair cost in accordance with the construction method according to the damage area or the section area and the construction method.

In step S107, the repair candidate list generator 142 determines whether the process of step S103 is performed on all the list generation target areas. When the process of step S103 is performed on all the list generation target areas (YES in step S107), the repair candidate list generator 142 performs a process of step S108. Conversely, when the process of step S103 is not performed on all the list generation target areas (NO in step S107), the repair candidate list generator 142 performs the process of step S102.

In step S108, the repair candidate list generator 142 generates the repair candidate list according to the process results of steps S102 to S106. The repair candidate list generator 142 may not include the repair candidate list in the list generation target area in which it is determined that there is no road surface damage in the process of step S103. That is, the repair candidate list generator 142 generates the repair candidate list in which the spot of the list generation target area in which it is determined that the degree of damage is “large” in the process of step S103, the structure, the construction method, and the repair cost are listed up. The repair candidate list generator 142 outputs the generated repair candidate list to the repair candidate list output unit 143.

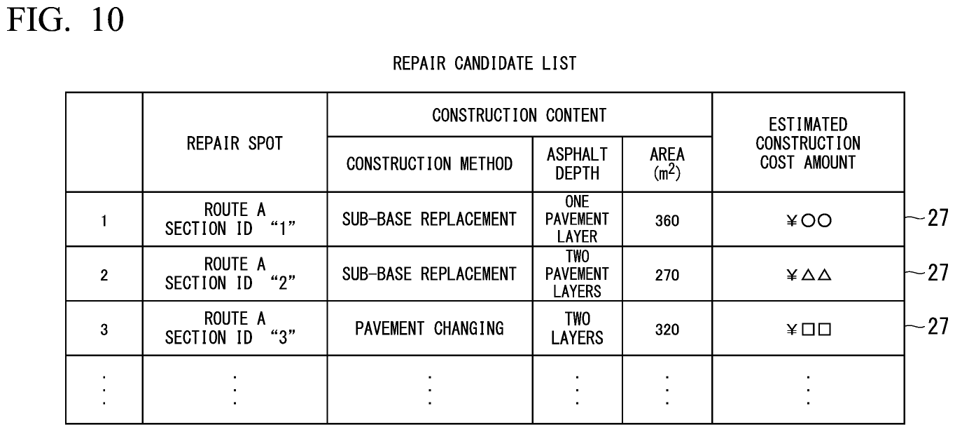

FIG. 10 is a diagram showing an example of a repair candidate list. The repair candidate list shown in FIG. 10 includes a plurality of records 27 in which information regarding the list generation target area in which it is determined that the repair is necessary (hereinafter referred to as “repair candidate records”) are registered. The repair candidate record 27 includes values of a repair spot, construction content, and an estimated construction cost amount. The value of the repair spot represents the list generation target area in which it is determined that repair is necessary. The value of the construction content represents details of the construction method performed on the list generation target area in which it is determined that repair is necessary. The value of the estimated construction cost amount represents an estimated amount of construction cost at which construction is necessary. The value of the estimated construction cost amount is repair cost calculated in the process of step S106.

The description will continue of FIG. 9.

In step S109, the repair candidate list output unit 143 stores the repair candidate list output from the repair candidate list generator 142 in the repair candidate list storage 17.

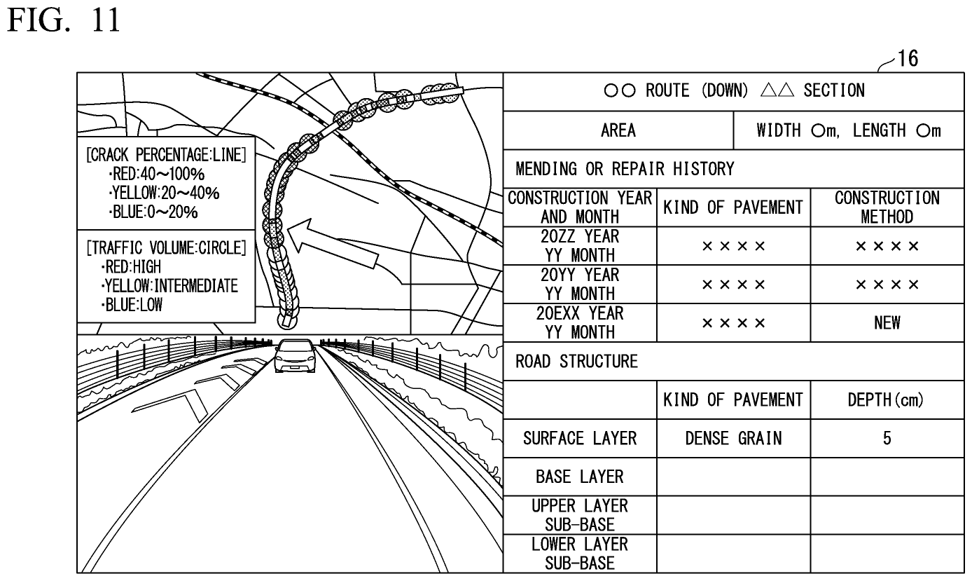

FIG. 11 is a diagram showing a screen example displayed on the display 16.

As shown in FIG. 11, information regarding a certain section of a certain route is displayed on the display 16. For example, in FIG. 11, information such as positional information on a map of the certain route, image data captured in the certain section, a road surface damage (for example, a pavement crack) occurring in the certain section, the width and the length of the section, the repair history, the road structure, and the like is displayed. In FIG. 11, the position of a circle indicated by an arrow represents the position of a section displayed on the display 16 and a circle represents the traffic volume of large vehicles.

The road maintenance management system 100 that has the foregoing configuration performs review determination of the structure of a road surface in addition to determination of damage of the road surface. Thus, the road maintenance management system 100 can determine whether it is good to repair the damage of the road surface from the structure of the original road surface. Then, when it is necessary to reexamine the structure of the road surface, the road maintenance management system 100 selects a construction method of repairing the construction of the road surface such as replacement of the sub-base or pavement changing and generates the repair candidate list. Therefore, it is possible to determine an appropriate maintenance repair method according to the degree of deterioration or a use situation of the road.

### Modification Example of First Embodiment

Hereinafter, a modification example of the first embodiment will be described.

When the road maintenance management system 100 includes a plurality of information processing devices, the functional units included in the road maintenance management system 100 can be distributed to the plurality of information processing devices. For example, the repair-related information input unit 11, the repair-related information register 12, the input information storage 13, and the list generator 14 are included in one information processing device, and the other information processing devices include the display controller 15, the display 16, and the repair candidate list storage 17. The foregoing configuration is an exemplary example. When the functional units included in the road maintenance management system 100 are included in the plurality of information processing devices, any information processing device may include any functional unit.

### Second Embodiment

Next, a second embodiment will be described. The second embodiment is an embodiment in which a repair candidate list is generated and a construction schedule is generated using the repair candidate list and construction information.

FIG. 12 is a diagram showing a configuration of a road maintenance management system 100a according to the second embodiment. The road maintenance management system 100a includes one information processing device or a plurality of information processing devices. When the road maintenance management system 100a includes one information processing device, the road maintenance management system 100a includes a CPU, a memory, and an auxiliary storage device and executes a road maintenance management program connected by a bus. The road maintenance management system 100a executes the road maintenance management program to function as a device that includes the repair-related information input unit 11, the repair-related information register 12, an input information storage 13, the list generator 14, the display controller 15, the display 16, the repair candidate list storage 17, a construction information register 18, and a schedule generator 19. Some or all of the functions of the road maintenance management system 100a may be realized using hardware such as ASIC, PLD, or FPGA. The road maintenance management program may be recorded on a computer-readable recording medium. The computer-readable recording medium is, for example, a storage device such as a flexible disc, a magneto-optical disc, a ROM, a portable medium such as a CD-ROM, or a hard disk contained in a computer system. The road maintenance management program may be transmitted via an electric communication line.

The road maintenance management system 100a is different from the road maintenance management system 100 in that an input information storage 13a is included instead of the input information storage 13 and the construction information register 18 and the schedule generator 19 are newly included. The other configuration of the road maintenance management system 100a is the same as that of the road maintenance management system 100. Therefore, the overall description of the road maintenance management system 100a will be omitted and the input information storage 13a, the construction information register 18, and the schedule generator 19 will be described.

The construction information register 18 is a registration unit that registers various kinds of information such as construction-related information, a construction rule, and a maintenance management policy input through an operation by a manager in the own system. The construction information register 18 includes a construction-related information acquisition unit 181, a construction rule acquisition unit 182, and a maintenance management policy acquisition unit 183.

The construction-related information acquisition unit 181 is a functional unit that acquires construction-related information. The construction-related information is information regarding construction for repair and includes, for example, information necessary to perform construction, such as standard man-hours, construction vehicle availability, material availability, and material procurement possibility. The construction-related information acquisition unit 181 stores the acquired construction-related information in the input information storage 13a.

The standard man-hour represents a workload which is a standard necessary to complete certain work. The construction vehicle availability represents availability of a vehicle used for construction. The material availability represents availability of materials used for construction. The material procurement possibility represents whether materials used for construction can be procured. When materials can be procured, information indicating when materials can be procured is also included in the material procurement possibility.

The construction rule acquisition unit 182 is a functional unit that acquires a construction rule. The construction rule is information regarding a rule (condition) decided in construction and includes, for example, an upper limit of construction cost per unit, a work date (for example, only weekend or only weekdays, or the like), and information regarding a condition which is obeyed to perform construction of one side of a lane. The construction-related information acquisition unit 181 stores the acquired construction rule in the input information storage 13a.

The maintenance management policy acquisition unit 183 is a functional unit that acquires a maintenance management policy. The maintenance management policy is an item emphasized in generation of a construction schedule and includes, for example, information such as life cycle cost emphasis and safety emphasis. The maintenance management policy acquisition unit 183 stores the acquired maintenance management policy in the input information storage 13a.

The input information storage 13a is storage unit that stores the management road information table, the road structure information table, the road surface damage state table, the road environment table, the repair history table, the construction method and structure list table, the maintenance management level, the construction-related information, the construction rule, and the maintenance management policy acquired by the repair-related information input unit 11, the repair-related information register 12, and the construction information register 18. The input information storage 13a is configured using a storage device such as a magnetic hard disk device or a semiconductor storage device. The input information storage 13a may store image data and map information when a management target road is photographed by a camera of an inspector at the time of inspection.

The schedule generator 19 includes a construction condition registration unit 191, a construction schedule generator 192, and a construction schedule output unit 193.

The construction condition registration unit 191 is a registration unit that registers a condition which is met in construction (hereinafter referred to as a “construction condition”). The condition which is met in construction is, for example, a budget and a construction period.

The construction schedule generator 192 is a generation unit that generates a construction schedule according to the information stored in the input information storage 13a, the repair target list stored in the repair candidate list storage 17, and the construction condition registered by the construction condition registration unit 191.

The construction schedule output unit 193 is a functional unit that outputs a construction schedule generated by the construction schedule generator 192. For example, the construction schedule output unit 193 may transmit the construction schedule to an external device via a network, may be connected to a printing device and output the construction schedule to a medium via the printing device, may output the construction schedule to an external recording medium, may cause the display 16 to display the construction schedule via the display controller 15, or may cause a storage unit (not shown) to store the construction schedule.

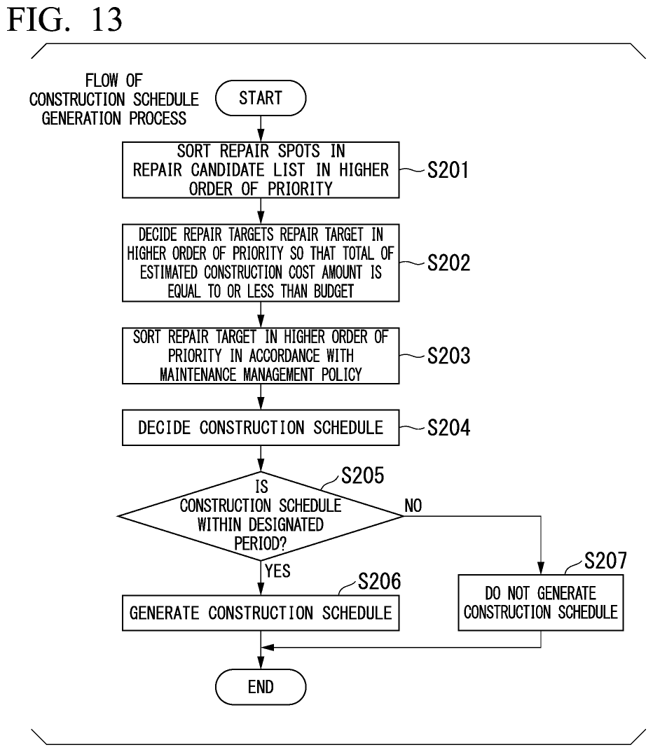

FIG. 13 is a flowchart showing a flow of a construction schedule generation process performed by the road maintenance management system 100a according to the second embodiment.

In step S201, the construction schedule generator 192 sorts repair spots in the repair candidate list stored in the repair candidate list storage 17 in an ascending order of priority. Specifically, the construction schedule generator 192 reads the repair candidate list stored in the repair candidate list storage 17. Subsequently, the construction schedule generator 192 sorts the repair spots in the read repair candidate list in an ascending order of first priority.

The first priority is lowered in order of the degree of damage, a damage area, and structure review. This is an order in which necessity of repair is higher. Therefore, the construction schedule generator 192 first sorts repair spots in the repair candidate list in an ascending order of the degree of damage. Subsequently, the construction schedule generator 192 sorts repair spots with the same degree of damage in an ascending order of damage areas. Then, the construction schedule generator 192 sorts repair spots with the same degree of damage and the same damage area in accordance with presence or absence of the structure review. For example, the construction schedule generator 192 sorts repair spots so that the structure review is higher than absence of the structure review.

In step S202, the construction schedule generator 192 adds an estimated construction cost amounts in an ascending order of priority in the repair candidate list after the sorting and decides repair targets so that a total of the estimated construction cost amount is equal to or less than a budget registered by the construction condition registration unit 191. For example, the construction schedule generator 192 adds the estimated construction cost amount in the higher order of priority in the repair candidate list after the sorting and decides repair spots as repair targets immediately before the total of the estimated construction cost amount exceeds the registered budget.

In step S203, the construction schedule generator 192 sorts the decided repair targets in a higher construction method order of priority in accordance with the maintenance management policy stored in the input information storage 13a. In general, cost of sub-base replacement is three times or more and a construction period is four times or more than cost of pavement arrangement or overlay. Accordingly, when a lift cycle cost is emphasized as the maintenance management policy, the construction schedule generator 192 sorts repair targets so that the repair targets of pavement arrangement or overlay of the construction method are higher than the repair targets of the sub-base replacement in priority. When safety is emphasized as the maintenance management policy, the construction schedule generator 192 sorts the repair targets so that the repair targets of the sub-base replacement of the construction method is higher than the repair targets of pavement arrangement or overlay in priority.

In step S204, the construction schedule generator 192 decides a construction schedule according to the construction-related information and the construction rule stored in the input information storage 13a and the information regarding the repair targets after the process of step S203. For example, when work on only weekend is decided as the construction rule, the construction schedule generator 192 decides the construction schedule so that the construction schedule is only weekend.

In step S205, the construction schedule generator 192 determines whether the decided construction schedule is within a construction period registered by the construction condition registration unit 191. When the decided construction schedule is within the construction period (YES in step S205), the construction schedule generator 192 performs the process of step S206. Conversely, when the decided construction schedule is not within the construction period (NO in step S205), the construction schedule generator 192 performs the process of step S207.

In step S206, the construction schedule generator 192 generates a construction schedule in accordance with the decided construction schedule. For example, when work is decided to be performed on only weekend as the construction rule, the construction schedule generator 192 generates the construction schedule in accordance with the construction schedule decided so that the construction schedule is only weekend. The construction schedule generator 192 outputs the generated construction schedule to the outside. The construction schedule generator 192 may store the generated construction schedule in an internal storage unit.

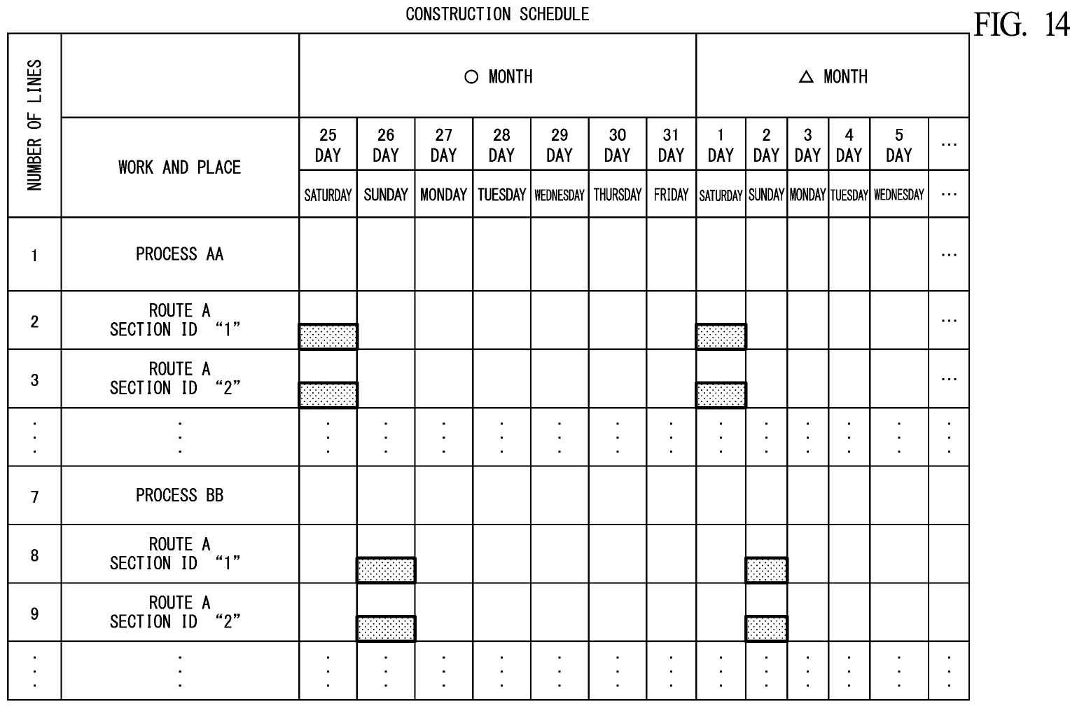

FIG. 14 is a diagram showing an example of a construction schedule. The construction schedule shown in FIG. 14 is an example of a construction schedule when work is decided to be performed on only weekend as the construction rule. As shown in FIG. 14, since work is decided to be performed on only weekend as the construction rule, the construction schedule is generated so that construction work for a repair target is all performed on one of Saturday and Sunday.

Back in FIG. 13, the description will continue.

In step S207, the construction schedule generator 192 does not generate the construction schedule.

In the road maintenance management system 100a that has the foregoing configuration, it is possible to obtain the same advantageous effects as those of the first embodiment.

The road maintenance management system 100a sorts repair spots which are repair targets in the repair candidate list in higher order of priority. Thereafter, the road maintenance management system 100a decides the repair targets so that the estimated construction cost amount does not exceed a budget. Thereafter, the road maintenance management system 100a sorts the decided repair targets according to priority of a construction method in accordance with the maintenance management policy. Thus, the priority of the repair targets in accordance with the maintenance management policy increases. Then, the road maintenance management system 100a decides the construction schedule of the repair targets after the sorting and generates the construction schedule. Therefore, it is possible to generate the construction schedule that contributes to the maintenance management policy while the budget is met.

### Modification Example of Second Embodiment

Hereinafter, a modification example of the second embodiment will be described.

When the road maintenance management system 100a includes a plurality of information processing devices, the functional units included in the road maintenance management system 100a can be distributed to the plurality of information processing devices. For example, the repair-related information input unit 11, the repair-related information register 12, the input information storage 13a, the list generator 14, and the construction information register 18 are included in one information processing device, and the other information processing devices include the display controller 15, the display 16, the repair candidate list storage 17, and the schedule generator 19. The foregoing configuration is an exemplary example. When the functional units included in the road maintenance management system 100a are included in the plurality of information processing devices, any information processing device may include any functional unit.

According to at least one of the above-described embodiments, a road maintenance management system includes: a road surface damage state information acquisition unit configured to acquire road surface damage state information indicating a damage state of a road surface of a management target; a road environment information acquisition unit configured to acquire environment information of the road surface; a construction method and structure list acquisition unit configured to acquire a construction method and structure list indicated by a construction method related to a repair of a road surface in accordance with a structure level of the road surface; and a repair candidate list generator configured to review a structure of the road surface in accordance with the environment information of the road surface and generate a repair candidate list including a repair method for the road surface according to a determination result for each a repair candidate of the road surface using the road surface damage state information and the construction method and structure list. Thus, it is possible to determine an appropriate maintenance repair method according to the degree of deterioration or a use situation of a road.

While some embodiments of the present invention have been described, these embodiments have been presented by way of example and are not intended to limit the scope of the invention. These embodiments can be implemented in various other forms, and various omissions, substitutions, and changes can be made without departing from the spirit of the invention. These embodiments and modifications thereof are included in the scope or spirit of the invention, as well as in the scope of the invention described in the claims and their equivalents.

What is claimed is:

1. A road maintenance management system comprising:
a road surface damage state information acquisition unit configured to acquire road surface damage state information indicating a damage state of a road surface of a management target;
a road environment information acquisition unit configured to acquire environment information of the road surface;
a construction method and structure list acquisition unit configured to acquire a construction method and structure list indicated by information regarding a repair of a road surface in accordance with a structure level of the road surface; and
a repair candidate list generator configured to review a structure of the road surface in accordance with the environment information of the road surface and generate a repair candidate list including a repair method for the road surface according to a determination result for each a repair candidate of the road surface using the road surface damage state information and the construction method and structure list.

2. The road maintenance management system according to claim 1, wherein the repair candidate list generator determines that the review of the structure of the road surface is necessary when an elapsed period from previous repair on the road surface is shorter than a durability period of use during a certain period provided for the road surface.

3. The road maintenance management system according to claim 1, further comprising:
a construction-related information acquisition unit configured to acquire construction-related information regarding a construction for the repair;
a construction rule acquisition unit configured to acquire a construction rule which is a condition to be obeyed in the construction; and
a construction schedule generator configured to generate a construction schedule by determining a construction plan to repair the road surface using the repair candidate list, the construction rule, and the construction-related information.

4. The road maintenance management system according to claim 3,
wherein the repair candidate list generator is configured to generate the repair candidate list further including an estimated construction cost amount necessary in a construction for the repair of each repair candidate of the road surface, and
wherein the construction schedule generator is configured to generate a construction schedule by sorting repair target candidates of the repair candidate list in an ascending order of repair necessity priority, adding the construction cost estimated amount in an ascending order of priority of the sorted repair target candidates, deciding a repair target among the repair target candidates so that a sum of the construction cost estimated amounts does not exceed a budget designated in advance, and deciding a construction plan to repair the road surface of the decided repair target.

5. The road maintenance management system according to claim 4, wherein the construction schedule generator is configured to generate the construction schedule by sorting the decided repair targets in a construction method order of higher priority in accordance with a maintenance management policy indicating one policy of life cycle cost emphasis or safety emphasis to be emphasized in the generation of the construction schedule.

6. A road maintenance management method comprising:
acquiring road surface damage state information indicating a damage state of a road surface of a management target;
acquiring environment information of the road surface;
acquiring a construction method and structure list indicated by information regarding a repair of a road surface in accordance with a structure level of the road surface; and
reviewing a structure of the road surface in accordance with the environment information of the road surface and generating a repair candidate list including a repair method for the road surface according to a determination result for each a repair candidate of the road surface using the road surface damage state information and the construction method and structure list.

7. A non-transitory recording medium which records a computer program for executing a method in a computer, the method, comprising:
acquiring road surface damage state information indicating a damage state of a road surface of a management target;
acquiring environment information of the road surface;
acquiring a construction method and structure list indicated by information regarding a repair of a road surface in accordance with a structure level of the road surface; and
reviewing a structure of the road surface in accordance with the environment information of the road surface and generating a repair candidate list including a repair method for the road surface according to a determination result for each a repair candidate of the road surface using the road surface damage state information and the construction method and structure list.
